(19) United States
(12) Patent Application Publication
(10) Pub. No.: US 2013/0009763 A1
(43) Pub. Date: Jan. 10, 2013

(54) CONTROLLER FOR TIRE PRESSURE MONITORING SYSTEM

(75) Inventor: Shinichi KOGA, Aichi (JP)

(73) Assignee: KABUSHIKI KAISHA TOKAI RIKA DENKI SEISAKUSHO, Aichi (JP)

(21) Appl. No.: 13/533,230

(22) Filed: Jun. 26, 2012

(30) Foreign Application Priority Data
Jul. 4, 2011 (JP) 2011-148338

(51) Int. Cl. B60C 23/02

(52) U.S. Cl. 340/442

(57) ABSTRACT

A controller for a tire pressure monitoring system includes a control unit that receives information signal related to tire air pressure and tire temperature from a sensor unit arranged in each tire. The control unit notifies a user when determining from the information signal received subsequent to pressure adjustment of the corresponding tire that the tire air pressure of the corresponding tire would be excluded from a recommended pressure range as the present tire temperature changes to a monitoring subject temperature.

### CROSS-REFERENCE TO RELATED APPLICATIONS

This application is based upon and claims the benefit of priority from prior Japanese Patent Application No. 2011-148338, filed on Jul. 4, 2011, the entire contents of which are incorporated herein by reference.

### BACKGROUND

The present invention relates to a controller for a tire pressure monitoring system.

A tire pressure monitoring system (TPMS) that monitors the air pressure of tires is known in the art. A vehicle provided with the TPMS includes a sensor unit arranged in each tire to detect the tire air pressure of the corresponding tire. Each sensor unit transmits an information signal, which includes the detection result of the tire air pressure, to a receiver. Based on the received information signal, the receiver determines whether or not the tire air pressure is less than or equal to a threshold. When the tire air pressure is less than or equal to the threshold, the receiver generates a warning for a user with an indicator (refer to, for example, Japanese Laid-Open Patent Publication No. 2003-211925).

### SUMMARY OF THE INVENTION

The tire air pressure increases as the tire temperature increases (Boyle-Charles's Law). The tire air temperature is increased by the ambient temperature and frictional heat produced as the vehicle travels along a road.

Thus, when setting the tire air pressure to a recommended air pressure in a state in which the tire temperature is high, the tire air pressure may become less than or equal to the recommended air pressure as the tire temperature decreases to normal. In such a case, the user would not be aware that the present tire air pressure would differ from the recommended air pressure under a normal temperature. Further, when the tire temperature returns to normal and the tire air pressure becomes less than or equal to the threshold, a warning may be generated even though air has not leaked from the tire subsequent to the adjustment of the tire air pressure.

The present invention provides a controller for a tire pressure monitoring system that prompts a user to adjust a tire air pressure so as to obtain the tire air pressure that would be in a recommended air pressure range under a monitoring subject temperature.

One aspect of the present invention is a controller for a tire pressure monitoring system. The tire pressure monitoring system includes a sensor unit arranged in each tire. The controller includes a control unit that receives an information signal related to tire air pressure and tire temperature from the sensor unit. When determining from the information signal that the tire air pressure of the tire corresponding to the sensor unit is less than or equal to a threshold, the control unit generates a warning indicating a pressure decrease. The control unit is configured to notify a user when determining from the information signal received subsequent to pressure adjustment of the corresponding tire that the tire air pressure of the corresponding tire would be excluded from a recommended pressure range as the present tire temperature changes to a monitoring subject temperature.

A further aspect of the present invention is a tire pressure monitoring system including a sensor unit, which is arranged in each tire, and a control unit. The control unit receives an information signal related to tire air pressure and tire temperature from the sensor unit. When determining that the tire air pressure of the tire corresponding to the sensor unit is less than or equal to a threshold, the control unit generates a warning indicating a pressure decrease. The control unit is configured to notify a user when determining from the information signal received subsequent to pressure adjustment of the corresponding tire that the tire air pressure of the corresponding tire would be excluded from a recommended pressure range as the present tire temperature changes to a monitoring subject temperature.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a tire pressure monitoring system in a first embodiment;

FIG. 2 is a graph showing the relationship of the tire air pressure and tire temperature in the first embodiment;

FIG. 3 is a graph showing the relationship of the tire air pressure and tire temperature in a second embodiment; and

FIG. 4 is a graph showing the relationship of the tire air pressure and tire temperature in a third embodiment.

### DETAILED DESCRIPTION OF THE INVENTION

### First Embodiment

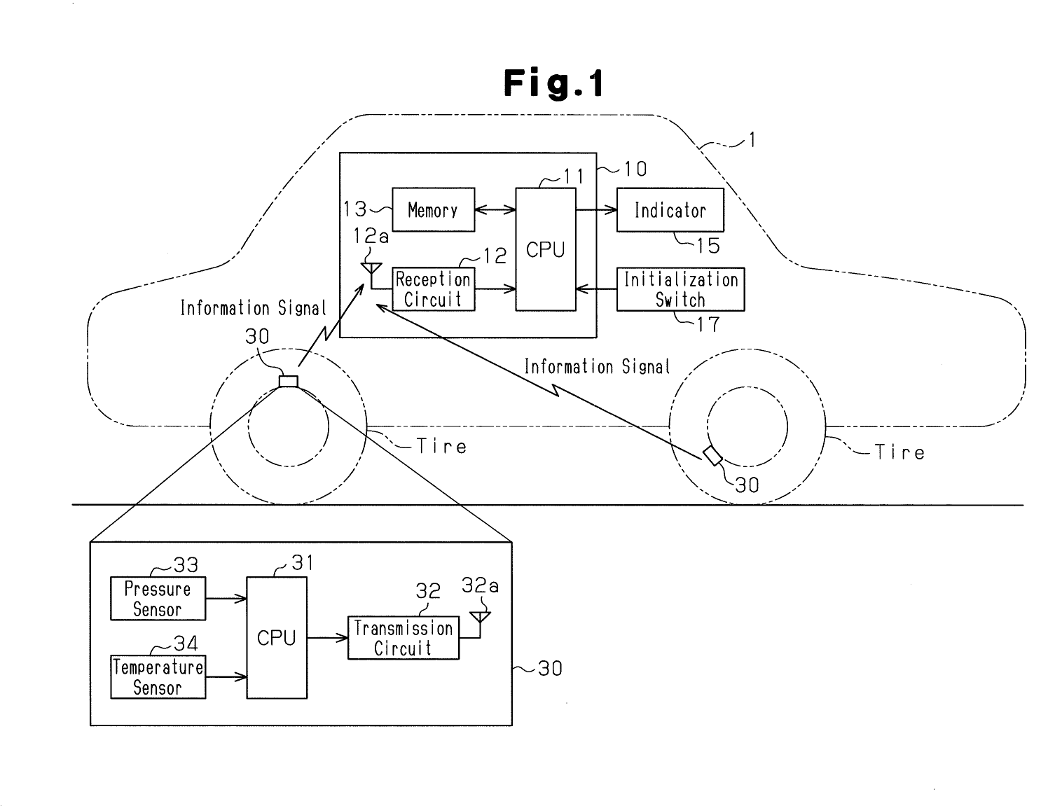

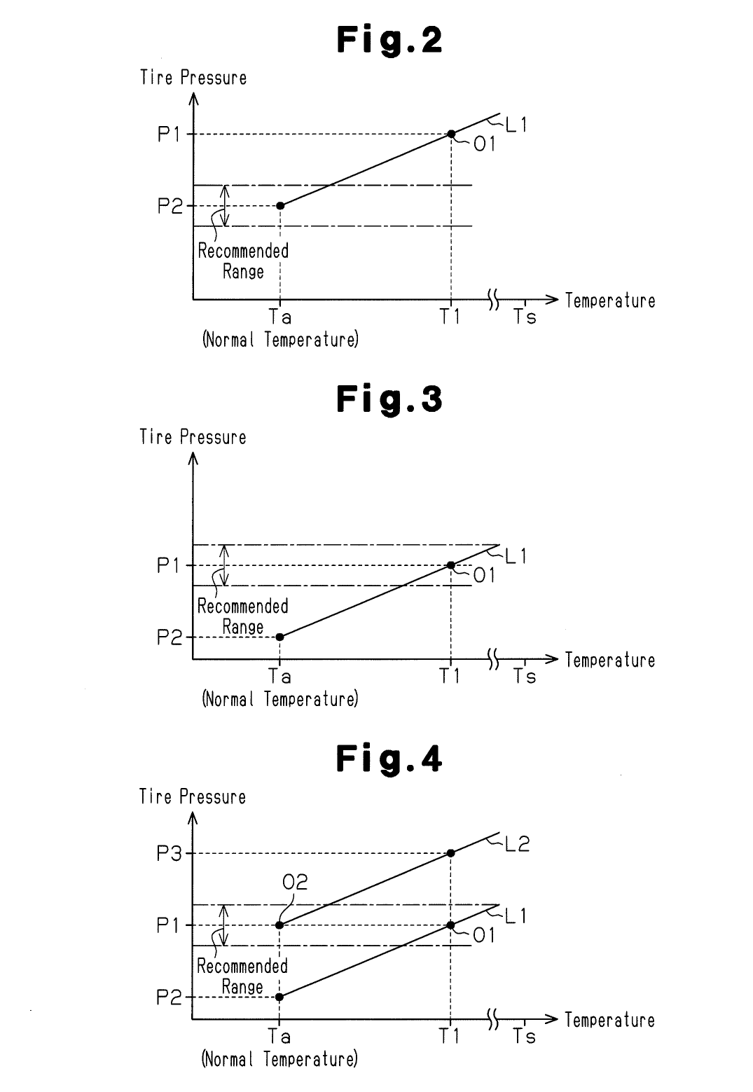

A first embodiment of a controller for a tire pressure monitoring system (TPMS) will now be described with reference to FIGS. 1 and 2.

Referring to FIG. 1, a vehicle 1 includes a sensor unit 30 arranged in the valve of each tire. As shown by the enlarged section in the lower part of FIG. 1, the sensor unit 30 includes a pressure sensor 33, a temperature sensor 34, a central processing unit (CPU) 31, a transmission circuit 32, and a transmission antenna 32a.

The pressure sensor 33 detects the tire air pressure of the corresponding tire and sends the detection result to the CPU 31. Based on the detection result of the pressure sensor 33, the CPU 31 checks the tire air pressure.

The temperature sensor 34 detects the tire temperature of the corresponding tire and sends the detection result to the CPU 31. Based on the detection result of the temperature sensor 34, the CPU 31 checks the tire temperature.

The CPU 31 generates an information signal including information related to the tire air pressure and tire temperature in fixed cycles and sends the information signal to the transmission circuit 32. The transmission circuit 32 modulates the information signal and transmits the modulated information signal from the transmission antenna 32a.

A receiver 10 is installed in the vehicle 1. The receiver 10 includes a CPU 11, which serves as a control unit, a reception circuit 12, a reception antenna 12a, and a memory 13. The CPU 11 is electrically connected to an indicator 15 and an initialization switch 17.

The memory 13 stores a tire air pressure threshold used to determine whether or not the tire air pressure is appropriate. The reception circuit 12 receives the information signal with the reception antenna 12a. Then, the reception circuit 12 demodulates the received information signal and sends the demodulated information signal to the CPU 11. The CPU 11 recognizes the tire air pressure and the tire temperature from the demodulated information signal.

The initialization switch 17 is arranged in the vehicle 1 and may be operated by a user. The initialization switch 17 sends an operation signal that is in accordance with the user's operation to the CPU 11. In response to the operation signal from the initialization switch 17, the CPU 11 enters an initialization mode. When the user adjusts the tire air pressure to be in a recommended pressure range (hereinafter referred to as “recommended range”) under the present tire temperature, the user is required to operate the initialization switch 17. The recommended range is set based on pressure recommended by, for example, the manufacturer.

In the initialization mode, the CPU 11 recognizes the tire air pressure P1 and the tire temperature T1, which are included in the information signal that is first received. Then, the CPU 11 determines whether or not the tire air pressure would be excluded from the recommended range as the present tire temperature T1 changes to a normal temperature Ta. This determination is given using, for example, a straight line L1 (function) shown in FIG. 2. The straight line L1 passes through an intersection point O1 of the tire air pressure P1 and the tire temperature T1 and has a gradient that is in accordance with the Boyle-Charles's Law. Based on the line L1, the CPU 11 calculates a tire air pressure P2 that would be obtained when the present tire temperature T1 changes to the normal temperature Ta. Namely, the CPU 11 performs a temperature correction process to estimate the tire air pressure P2 that would be obtained under the normal pressure Ta from the present tire air pressure P1 under the present tire temperature T1. For example, the normal temperature Ta is set beforehand based on an average tire temperature. The normal temperature Ta is one example of a monitoring subject temperature, and the straight line L1 is one example of a correction function.

The CPU 11 determines whether or not the tire air pressure P2, which has been estimated through the temperature correction process, is within the recommended range. When the tire air pressure P2 is within the recommended range, the CPU 11 continues the initialization mode. In this case, for example, the CPU 11 decreases the value of the tire air pressure P2 by a predetermined ratio (e.g., fixed ratio) to set the tire air pressure threshold. Then, the CPU 11 stores the tire air pressure threshold in the memory 13 and terminates the initialization mode.

When receiving an information signal after terminating the initialization mode, based on the information signal (present tire air pressure and present tire temperature), the CPU 11 performs temperature correction process on the present tire air pressure in the same manner as described above to obtain the tire air pressure for the normal temperature Ta. When the tire air pressure for the normal temperature Ta, which is obtained through the temperature correction process, is less than or equal to the tire air pressure threshold stored in the memory 13, the CPU 11 generates a warning related to decrease in air pressure with the indicator 15.

In the initialization mode, when the tire air pressure P2 estimated through the temperature correction process is excluded from the recommended range, the CPU 11 terminates the initialization mode without setting the tire air pressure threshold, that is, without initializing the threshold. Then, the CPU 11 notifies the user with the indicator 15 that initialization of the tire air pressure threshold has been restricted (suspended in the present example). This allows the user to acknowledge that the present tire air pressure, which has been adjusted, will not be in the recommended range under the normal temperature.

The TPMS controller of the first embodiment has the advantages described below.

(1) The initialization mode starts when the initialization switch 17 is operated. In the initialization mode, the CPU 11 determines from the information signal, which is received subsequent to tire air pressure adjustment, whether or not the tire air pressure P2, which would be obtained when the present tire temperature T1 changes to the normal temperature Ta, would be within the recommended range. When the tire air pressure P2 is excluded from the recommended range, the CPU 11 does not set the tire air pressure threshold and notifies the user that initialization of the tire air pressure threshold has been restricted.

Thus, the user may acknowledge from the initialization restriction notification that the present tire air pressure that has been adjusted will be excluded from the recommended range under the normal temperature Ta. This prompts the user to adjust the tire air pressure to obtain the tire air pressure that would be in the recommended range under the normal temperature Ta. In this case, the user may wait until the present tire temperature T1 returns to the normal temperature Ta before readjusting the tire air pressure to the recommended range. Alternatively, the user may adjust the present tire air pressure P1 to a relatively high air pressure so that the tire air pressure P2 would be in the recommended range under the normal temperature Ta.

Further, the first embodiment prevents the tire air pressure threshold from being set based on a tire air pressure that would be excluded from the recommended range under the normal temperature. Thus, an accurate tire air pressure threshold may be set.

(2) In the initialization mode, the CPU 11 calculates the tire air pressure P2 under the normal temperature Ta based on the tire air pressure P1 and the tire temperature T1 included in the information signal received subsequent to tire air pressure adjustment by the user. When the calculated tire air pressure P2 is excluded from the recommended rage, the CPU 11 notifies the user of the initialization restriction. In this manner, the tire air pressure P2 for the normal temperature Ta is estimated taking into consideration the present tire air pressure P1 and the present tire temperature T1. In other words, the determination of whether or not the tire air pressure P2 would be excluded from the recommended rage is based on the present tire conditions. This increases the accuracy of the determination.

### Second Embodiment

A second embodiment will now be described with reference to FIG. 3. In the second embodiment, the configuration of the TPMS is substantially the same as that of the first embodiment shown in FIG. 1.

In the second embodiment, even when the tire air pressure P2 under the normal temperature Ta calculated from the present tire conditions would be excluded from the recommended range, the CPU 11 decreases the value of the calculated tire air pressure P2 by a predetermined ratio (e.g., fixed ratio) to set the tire air pressure threshold. Here, the CPU 11 notifies the user with the indicator 15 that the tire air pressure may be excluded from the recommended range under the normal temperature Ta. The remaining configuration of the second embodiment is the same as the first embodiment.

The TPMS controller of the second embodiment has the advantages described below.

(3) Even when the calculated tire air pressure P2 is excluded from the recommended range, the CPU 11 performs initialization to set the tire air pressure threshold from the present tire conditions. Further, the user acknowledges that the tire air pressure may be excluded from the recommended range under the normal temperature Ta. Accordingly, the user may wait until the present tire temperature T1 returns to the normal temperature Ta before readjusting the tire air pressure to the recommended range. Alternatively, the user may adjust the present tire air pressure P1 to a relatively high air pressure so that the tire air pressure P2 would be in the recommended range under the normal temperature Ta.

### Third Embodiment

A third embodiment will now be described with reference to FIG. 4. The configuration of the third embodiment is substantially the same as the configuration of the TPMS of the first embodiment shown in FIG. 1.

In the third embodiment, when calculations based on the present tire conditions indicate that the tire air pressure P2 would be excluded from the recommended range under the normal temperature Ta, the CPU 11 uses the indicator 15 to notify the user of a tire air pressure (tire air pressure correction value) that would be suitable for the present tire temperature T1 so as to obtain a tire air pressure (tire air pressure target value) that would be in the recommended range under the normal temperature Ta.

For example, referring to FIG. 4, the memory 13 stores the function of a straight line L2 beforehand. The straight line L2 is derived from the tire air pressure target value (e.g., P1 in FIG. 4) and the monitoring subject temperature (normal temperature Ta). The straight line L2 has a gradient that is in accordance with the Boyle-Charles's Law and passes through an intersection point O2 of the normal temperature Ta and the tire air pressure target value (P1). The CPU 11 uses the straight line L2 to calculate a tire air pressure P3 (tire air pressure correction value) that is suitable for the present tire temperature T1. The straight line L2 is one example of a correction function.

The CPU 11 recognizes the tire air pressure P1 and the tire temperature T1 included in the information signal that is first received in the initialization mode. Then, the CPU 11 calculates the tire air pressure P2 that would be obtained under the normal temperature Ta from the straight line L1 based on the tire air pressure P1 and the tire temperature T1. When the tire air pressure P2 is excluded from the recommended range, the CPU 11 uses the straight line L2 to calculate the suitable tire air pressure P3 that should be set under the tire temperature T1. The CPU 11 notifies the user of the value of the tire air pressure P3 with the indicator 15.

As a result, the user may check the display of the indicator 15 to adjust the present tire air pressure P1 to the suitable tire air pressure P3. This keeps the tire air pressure in the recommended range when the present tire temperature T1 returns to the normal temperature Ta.

The remaining configuration of the third embodiment is the same as the first embodiment. Further, the third embodiment may be applied to the first embodiment and the second embodiment.

The TPMS controller of the third embodiment has the advantages described below.

(4) If the CPU 11 determines that the tire air pressure P2 would be excluded from the recommended range when the present tire temperature T1 returns to the normal temperature Ta, the CPU 11 uses the indicator 15 to notify the user of the suitable tire air pressure P3 that should be set for the present tire temperature T1. Accordingly, the user may adjust the tire air pressure in accordance with the indicator 15 and set the tire air pressure to be within the recommended range under the normal temperature Ta.

### Fourth Embodiment

A fourth embodiment will now be described with reference to FIGS. 2 to 4. The configuration of the fourth embodiment is substantially the same as the configuration of the TPMS of the first embodiment shown in FIG. 1.

In the fourth embodiment, the calculation of the tire air pressure P2 for the normal temperature Ta based on the present tire conditions and the determination of whether or not the calculated tire air pressure P2 is within the recommended range are eliminated.

The memory 13 stores a tire temperature threshold Ts. The tire temperature threshold Ts is set to a value exceeding a tire temperature range corresponding to expected changes in the ambient temperature. When the tire temperature is greater than or equal to the tire temperature threshold Ts, it may be expected that the rise in tire temperature is caused by the traveling vehicle rather than changes in the ambient temperature.

The fourth embodiment may be applied to, for example, the first embodiment (FIG. 2). In such a case, when the tire temperature in the information signal received during the initialization mode is greater than or equal to the tire temperature threshold Ts, the CPU 11 terminates the initialization mode without setting the tire air pressure threshold and uses the indicator 15 to notify the user that the initialization has been restricted.

More specifically, even if the tire air pressure is adjusted when the present tire temperature is greater than or equal to the tire temperature threshold Ts, the tire air pressure may be excluded from the recommended range as the tire temperature subsequently changes to the normal temperature Ta. Therefore, the CPU 11 terminates the initialization mode without setting the tire air pressure threshold. In this case, for example, the user may wait until the present tire temperature T1 returns to the normal temperature Ta before readjusting the tire air pressure to the recommended range. Alternatively, the user may adjust the present tire air pressure P1 to a relatively high pressure so as to obtain a tire air pressure P2 that is within the recommended range under the normal temperature Ta.

Further, for example, the fourth embodiment may be applied to the second embodiment (FIG. 3). In such a case, when the tire temperature in the information signal received in the initialization mode is greater than or equal to the tire temperature threshold Ts, the CPU 11 uses the indicator 15 to notify the user that the tire air pressure may be excluded from the recommended range under the normal temperature Ta. Simultaneously, the CPU 11 sets the tire air pressure threshold in the same manner as the second embodiment and terminates the initialization.

Moreover, for example, the fourth embodiment may be applied to the third embodiment (FIG. 4). In such a case, when the tire temperature in the information signal received in the initialization mode is greater than or equal to the tire temperature threshold Ts, the CPU 11 uses the indicator 15 to notify the user of the suitable tire air pressure P3 for the present tire temperature.

Regardless of the embodiment to which the fourth embodiment is applied, the CPU 11 performs the initialization of the tire air pressure threshold in the same manner as the first embodiment when the tire temperature, which is included in the information signal received in the initialization mode, is less than the tire temperature threshold Ts.

The TPMS controller of the fourth embodiment has the advantages described below.

(5) The comparison of the tire temperature, which is included in the information signal, and the tire temperature threshold Ts, allows for determination of whether the tire air pressure is excluded from the recommended range under the normal temperature Ta. Accordingly, the same advantages as the first to third embodiments may be obtained through simple computation and determination processes. More specifically, the calculation process of the tire air pressure P2 under the normal temperature Ta based on the present tire conditions and the determination process of whether or not the tire air pressure P2 is within the recommended pressure may be eliminated.

It should be apparent to those skilled in the art that the present invention may be embodied in many other specific forms without departing from the spirit or scope of the invention. Particularly, it should be understood that the present invention may be embodied in the following forms.

In the above embodiments, the straight lines L1 and L2 are used as correction functions. However, a correction function does not have to be a straight line. Further, a correction table that is in accordance with a correction coefficient may be stored in the memory 13.

In the above embodiments, the monitoring subject temperature is the normal temperature Ta (average tire temperature). However, the monitoring subject temperature is not limited to the normal temperature Ta and may be any other tire temperature.

In the above embodiments, when the CPU 11 determines that the tire air pressure P2 is within the recommended range or the present tire temperature T1 in the information signal is less than the tire temperature threshold Ts, the CPU 11 sets the tire air pressure threshold by decreasing the value of the tire air pressure P2 by a predetermined ratio. However, when the above determination is made, the CPU 11 may wait until the present tire temperature T1 returns to the normal temperature Ta before setting the tire air pressure threshold by decreasing the tire air pressure under the normal temperature Ta by a predetermined ratio. Further, the CPU 11 may set the tire air pressure threshold based on the present tire air pressure P1, which is included in the information signal.

In the above embodiments, the notifications do not have to be generated by the indicator 15 and may be generated by a speaker through a voice.

In the above embodiments, when the tire air pressure P2 under the normal temperature Ta calculated in the initialization mode is excluded from the recommended range, the user is notified of such a situation (e.g., notification of initialization restriction in the first embodiment). However, such a notification may be generated even when the initialization mode is not being performed. For example, before shifting to the initialization node (before operating the initialization switch 17), the CPU 11 monitors changes in the tire air pressure based on the information signal to determine whether or not the user has completed tire air pressure adjustment. Then, when the CPU 11 determines that the tire air pressure adjustment has been completed, the CPU 11 further determines whether or not the tire air pressure adjustment has been properly performed and notifies the user of the determination result. For example, when the monitored tire air pressure becomes fixed after rising at a gradient of a specified value or greater, the CPU 11 determines that the user has completed tire air pressure adjustment. This eliminates the need to operate the initialization switch 17 and allows the user to recognize whether or not the tire air pressure subsequent to the adjustment would be within the recommended range under the normal temperature Ta.

In the above embodiments, the CPU 11 sets the tire air pressure threshold by decreasing the value of the temperature-corrected tire air pressure by a predetermined ratio. However, the setting of the tire air pressure threshold is not limited in such a manner. For example, the CPU 11 may set the tire air pressure threshold by decreasing the maximum value of the tire air pressure during a predetermined past period by a predetermined ratio (e.g., fixed ratio). In this configuration, the tire air pressure threshold is initialized when the initialization switch 17 is operated. Even in such a case, the user would be prompted to adjust the tire air pressure to be within the recommended range under the normal temperature Ta.

In the above embodiments, the sensor unit 30 transmits an information signal at predetermined cycles (fixed intervals) regardless of whether or not the vehicle 1 is traveling. However, the sensor unit 30 may transmit the information signal to the receiver 10 only when the vehicle 1 is traveling. In this case, for example, the sensor unit 30 may include an acceleration sensor that detects acceleration to determine whether or not the corresponding tire is rotating. Based on the detection result of the acceleration sensor, the CPU 31 transmits an information signal from the transmission circuit 32 in predetermined cycles (fixed cycles) only when the tire is rotating. Further, the sensor unit 30 may transmit the information signal in response to a request signal transmitted from the vehicle. Such configurations would also perform initialization in accordance with the operation of the initialization switch 17.

In the fourth embodiment, the CPU 11 determines whether or not the tire temperature in the information signal received during the initialization mode is greater than or equal to the tire temperature threshold Ts. However, the CPU 11 may determine whether or not the difference between the tire temperature in the information signal and the ambient temperature is greater than or equal to a predetermined value. In this case, an ambient temperature sensor may be arranged on the vehicle 1. The CPU 11 recognizes the ambient temperature from the ambient temperature sensor. When the CPU 11 determines that the difference between the tire temperature in the information signal and the ambient temperature is greater than or equal to the predetermined value, the CPU 11 notifies the user of such a determination. In this configuration, when the ambient temperature rises and the tire temperature becomes greater than or equal to the tire temperature threshold Ts, erroneous determination of the tire air pressure being excluded from the recommended range is suppressed.

In the above embodiments, a warning on the decrease in the tire air pressure is generated when the temperature-corrected tire air pressure becomes less than or equal to the tire air pressure threshold. However, without performing the temperature correction, a warning on the decrease in the tire air pressure may be generated when the tire air pressure included in the information signal becomes less than or equal to the tire air pressure threshold.

The present examples and embodiments are to be considered as illustrative and not restrictive, and the invention is not to be limited to the details given herein, but may be modified within the scope and equivalence of the appended claims.

1. A controller for a tire pressure monitoring system, wherein the tire pressure monitoring system includes a sensor unit arranged in each tire, the controller comprising a control unit that receives an information signal related to tire air pressure and tire temperature from the sensor unit and generates a warning indicating a pressure decrease when determining from the information signal that the tire air pressure of the tire corresponding to the sensor unit is less than or equal to a threshold,
wherein the control unit is configured to notify a user when determining from the information signal received subsequent to pressure adjustment of the corresponding tire that the tire air pressure of the corresponding tire would be excluded from a recommended pressure range as the present tire temperature changes to a monitoring subject temperature.

2. The controller according to claim 1, wherein
the tire pressure monitoring system is installed in a vehicle and includes an initialization switch operated by the user, and
the control unit is configured to
determine that the pressure adjustment has been performed when the initialization switch is operated and perform initialization of the threshold,
restrict the initialization of the threshold value when determining that the tire air pressure of the corresponding tire would be excluded from the recommended pressure range as the present tire temperature changes to the monitoring subject temperature, and
notify the user that the initialization of the threshold has been restricted.

3. The controller according to claim 1, wherein the control unit is configured to, based on the information signal received subsequent to the pressure adjustment of the corresponding tire, calculate a tire air pressure, which would be obtained under the monitoring subject temperature, from the present tire pressure under the present tire temperature and determine whether or not the calculated tire air pressure that would be obtained under the monitoring subject temperature would be excluded from the recommended pressure range.

4. The controller according to claim 1, wherein
the control unit is configured to determine whether or not the present tire temperature is greater than or equal to a tire temperature threshold based on the information signal received subsequent to the pressure adjustment of the corresponding tire,
the tire temperature threshold is set to a value exceeding a tire temperature range corresponding to expected changes in ambient temperature, and
when the present tire temperature is greater than or equal to the tire temperature threshold, the control unit determines that the tire air pressure of the corresponding tire would be excluded from the recommended pressure range as the present tire temperature changes to the monitoring subject temperature.

5. The controller according to claim 1, wherein when determining that the tire air pressure of the corresponding tire would be excluded from the recommended pressure range as the present tire temperature changes to the monitoring subject temperature, the control unit calculates a tire air pressure correction value that should be set under the present tire temperature to obtain a tire air pressure that would be in the recommended pressure range under the monitoring subject temperature and notifies the user of the tire air pressure correction value.

6. The controller according to claim 1, wherein the recommended pressure range is set based on pressure recommended by a manufacturer.

7. The controller according to claim 3, wherein the control unit is configured to use a first correction function derived from the information signal to calculate the tire air pressure that would be obtained under the monitoring subject temperature from the present tire pressure under the present tire temperature.

8. The controller according to claim 7, wherein the control unit is configured to set the threshold by decreasing a value of the tire air pressure obtained for the monitoring subject temperature calculated from the first correction function by a predetermined ratio.

9. The controller according to claim 5, further comprising a memory that stores a second correction function, which is derived from the monitoring subject temperature and a tire air pressure target value for the monitoring subject temperature,
wherein the control unit is configured to use the second correction function to calculate the tire air pressure correction value.

10. A tire pressure monitoring system comprising:
a sensor unit arranged in each tire; and
a control unit that receives an information signal related to tire air pressure and tire temperature from the sensor unit and generates a warning indicating a pressure decrease when determining from the information signal that the tire air pressure of the tire corresponding to the sensor unit is less than or equal to a threshold,
wherein the control unit is configured to notify a user when determining from the information signal received subsequent to pressure adjustment of the corresponding tire that the tire air pressure of the corresponding tire would be excluded from a recommended pressure range as the present tire temperature changes to a monitoring subject temperature.
